(19) United States
(12) Patent Application Publication
(10) Pub. No.: US 2002/0133620 A1
(43) Pub. Date: Sep. 19, 2002

(54) Access control in a network system

(76) Inventor: Michael R. Krause, Boulder Creek, CA (US)

Correspondence Address: HEWLETT-PACKARD COMPANY, Intellectual Property Administration, P.O. Box 272400, Fort Collins, CO, 80527-2400, US

(21) Appl. No.: 10/099,607

(22) Filed: Mar. 15, 2002

Related U.S. Application Data
(63) Continuation-in-part of application No. 09/578,019, filed on May 24, 2000.
(60) Provisional application No. 60/135,664, filed on May 24, 1999.
(60) Provisional application No. 60/154,150, filed on Sep. 15, 1999.

(51) Int. Cl. G06F 15/173

(52) U.S. Cl. 709/238

(57) ABSTRACT

A network system includes links and end stations coupled between the links. Types of end stations include endnodes which originate or consume frames and routing devices which route frames between the links. At least one end station includes an access control filter configured to restrict routes of frames from at least one end station on a selected routing path based on a selected frame header field, such as a next header field or an opcode field.

### CROSS REFERENCE TO RELATED APPLICATIONS

This patent application is a Continuation-in-part of U.S. patent application Ser. No. 09/578,019, entitled “RELIABLE MULTICAST,” filed May 24, 2000, and having Attorney Docket No. HP PDNO 10991834-2, which is herein incorporated by reference. U.S. patent application Ser. No. 09/578,019 is a Continuation-in-Part Application of U.S. patent application, filed May 23, 2000, entitled “RELIABLE DATAGRAM” having Attorney Docket No. HP PDNO 10991833-1 which is herein incorporated by reference. U.S. patent application Ser. No. 09/578,019 also claimed the benefit of the filing date of U.S. Provisional Patent Applications Serial No. 60/135,664, filed May 24, 1999 and having Attorney Docket No. HP PDNO 10991654-1; and Ser. No. 60/154,150, filed Sep. 15, 1999 and having Attorney Docket No. HP PDNO 10992562-1, both of which are herein incorporated by reference.

### THE FIELD OF THE INVENTION

The present invention generally relates to communication in network systems and more particularly to access control in network systems.

### BACKGROUND OF THE INVENTION

A traditional network system, such as a computer system, has an implicit ability to communicate between its own local processors and from the local processors to its own I/O adapters and the devices attached to its I/O adapters. Traditionally, processors communicate with other processors, memory, and other devices via processor-memory buses. I/O adapters communicate via buses attached to processor-memory buses. The processors and I/O adapters on a first computer system are typically not directly accessible to other processors and I/O adapters located on a second computer system.

In conventional distributed computer systems, distributed processes, which are on different nodes in the distributed computer system, typically employ transport services, to communicate. A source process on a first node communicates messages to a destination process on a second node via a transport service. A message is herein defined to be an application-defined unit of data exchange, which is a primitive unit of communication between cooperating sequential processes. Messages are typically packetized into frames for communication on an underlying communication services/fabrics. A frame is herein defined to be one unit of data encapsulated by a physical network protocol header and/or trailer.

Certain conventional distributed computer systems employ access control mechanisms to protect an endnode from unauthorized access by restricting routes through the underlying communication services/fabrics. A node in the distributed computer system is preferably protected against unauthorized access at several levels, such as application procell level, kernal level, hardware level, and the like.

For reasons stated above and for other reasons presented in greater detail in the description of the preferred embodiments section of the present specification, there is a need for improved access control in network systems, such as distributed computer systems, to permit efficient protection for an endnode to prevent unauthorized access by restricting routes through the underlying communication services/fabrics.

### SUMMARY OF THE INVENTION

One aspect of the present invention provides a network system having links and end stations coupled between the links. Types of end stations include endnodes which originate or consume frames and routing devices which route frames between the links. At least one end station includes an access control filter configured to restrict routes of frames from at least one end station on a selected routing path based on a selected frame header field.

### BRIEF DESCRIPTION OF THE DRAWINGS

FIG. 1 is a diagram of a distributed computer system.

FIG. 2 is a diagram of an example host processor node for the computer system of FIG. 1.

FIG. 3 is a diagram of a portion of a distributed computer system employing a reliable connection service to communicate between distributed processes.

FIG. 4 is a diagram of a portion of distributed computer system employing a reliable datagram service to communicate between distributed processes.

FIG. 5 is a diagram of an example host processor node for operation in a distributed computer system.

FIG. 6 is a diagram of a portion of a distributed computer system illustrating subnets in the distributed computer system.

FIG. 7 is a diagram of a switch for use in a distributed computer system.

FIG. 8 is a diagram of a portion of a distributed computer system.

FIG. 9A is a diagram of a work queue element (WQE) for operation in the distributed computer system of FIG. 8.

FIG. 9B is a diagram of the packetization process of a message created by the WQE of FIG. 9A into frames and flits.

FIG. 10A is a diagram of a message being transmitted with a reliable transport service illustrating frame transactions.

FIG. 10B is a diagram illustrating a reliable transport service illustrating flit transactions associated with the frame transactions of FIG. 10A.

FIG. 11 is a diagram of a layered architecture.

FIG. 12 is a diagram of a switch or router having an access control filter according to one embodiment of the present invention.

FIG. 13 is a diagram of an endnode having an access control filter according to one embodiment of the present invention.

FIG. 14 is a diagram of a frame header containing a next header field.

FIG. 15 is a diagram of a frame header containing an opcode field.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

One embodiment of the present invention is directed to a method and apparatus providing access control in a network system. In one embodiment, the access control mechanism according to the present invention protects an endnode from unauthorized access by restricting routes through a communication fabric. In one embodiment, the access control mechanism employs filtering at a network fabric element or end station, such as a switch, router, or endnode.

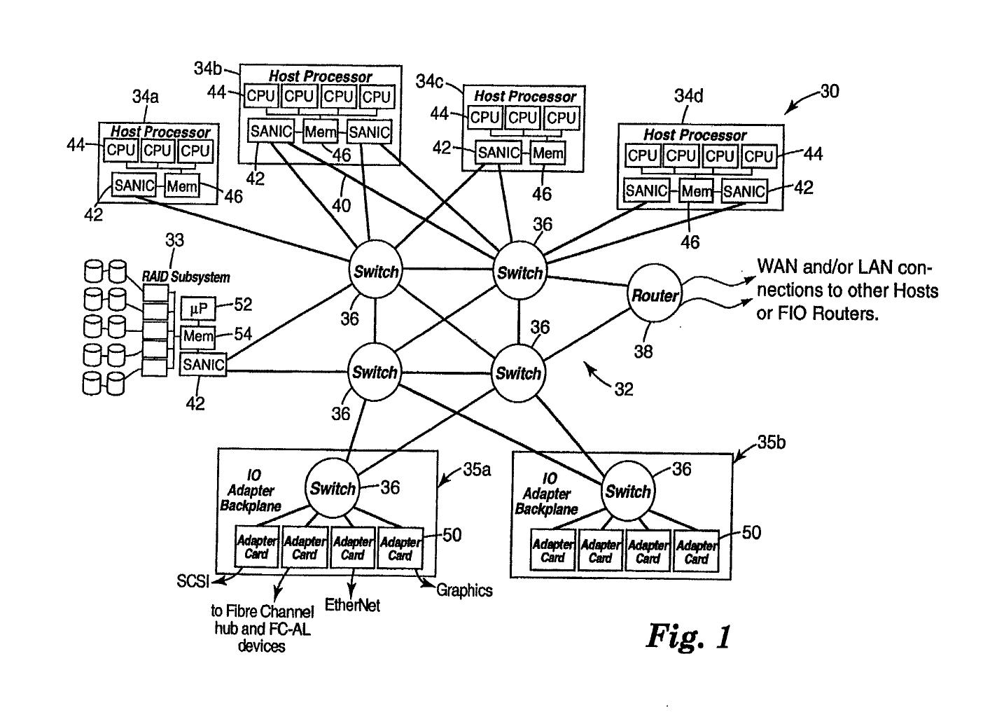

An example embodiment of a distributed computer system is illustrated generally at 30 in FIG. 1. Distributed computer system 30 is provided merely for illustrative purposes, and the embodiments of the present invention described below can be implemented on network systems of numerous other types and configurations. For example, network systems implementing the present invention can range from a small server with one processor and a few input/output (I/O) adapters to massively parallel supercomputer systems with hundreds or thousands of processors and thousands of I/O adapters. Furthermore, the present invention can be implemented in an infrastructure of remote computer systems connected by an internet or intranet.

Distributed computer system 30 includes a system area network (SAN) 32 which is a high-bandwidth, low-latency network interconnecting nodes within distributed computer system 30. A node is herein defined to be any device attached to one or more links of a network and forming the origin and/or destination of messages within the network. In the example distributed computer system 30, nodes include host processors 34a-34d; redundant array independent disk (RAID) subsystem 33; and I/O adapters 35a and 35b. The nodes illustrated in FIG. 1 are for illustrative purposes only, as SAN 32 can connect any number and any type of independent processor nodes, I/O adapter nodes, and I/O device nodes. Any one of the nodes can function as an endnode, which is herein defined to be a device that originates or finally consumes messages or frames in the distributed computer system.

A message is herein defined to be an application-defined unit of data exchange, which is a primitive unit of communication between cooperating sequential processes. A frame is herein defined to be one unit of data encapsulated by a physical network protocol header and/or trailer. The header generally provides control and routing information for directing the frame through SAN 32. The trailer generally contains control and cyclic redundancy check (CRC) data for ensuring frames are not delivered with corrupted contents.

SAN 32 is the communications and management infrastructure supporting both I/O and interprocess communication (IPC) within distributed computer system 30. SAN 32 includes a switched communications fabric (SAN FABRIC) allowing many devices to concurrently transfer data with high-bandwidth and low latency in a secure, remotely managed environment. Endnodes can communicate over multiple ports and utilize multiple paths through the SAN fabric. The multiple ports and paths through SAN 32 can be employed for fault tolerance and increased bandwidth data transfers.

SAN 32 includes switches 36 and routers 38. A switch is herein defined to be a device that connects multiple links 40 together and allows routing of frames from one link 40 to another link 40 within a subnet using a small header destination ID field. A router is herein defined to be a device that connects multiple links 40 together and is capable of routing frames from one link 40 in a first subnet to another link 40 in a second subnet using a large header destination address or source address.

In one embodiment, a link 40 is a full duplex channel between any two network fabric elements, such as endnodes, switches 36, or routers 38. Example suitable links 40 include, but are not limited to, copper cables, optical cables, and printed circuit copper traces on backplanes and printed circuit boards.

Endnodes, such as host processor endnodes 34 and I/O adapter endnodes 35, generate request frames and return acknowledgment frames. By contrast, switches 36 and routers 38 do not generate and consume frames. Switches 36 and routers 38 simply pass frames along. In the case of switches 36, the frames are passed along unmodified. For routers 38, the network header is modified slightly when the frame is routed. Endnodes, switches 36, and routers 38 are collectively referred to as end stations.

In distributed computer system 30, host processor nodes 34a-34d and RAID subsystem node 33 include at least one system area network interface controller (SANIC) 42. In one embodiment, each SANIC 42 is an endpoint that implements the SAN 32 interface in sufficient detail to source or sink frames transmitted on the SAN fabric. The SANICs 42 provide an interface to the host processors and I/O devices. In one embodiment the SANIC is implemented in hardware. In this SANIC hardware implementation, the SANIC hardware offloads much of CPU and I/O adapter communication overhead. This hardware implementation of the SANIC also permits multiple concurrent communications over a switched network without the traditional overhead associated with communicating protocols. In one embodiment, SAN 32 provides the I/O and IPC clients of distributed computer system 30 zero processor-copy data transfers without involving the operating system kernel process, and employs hardware to provide reliable, fault tolerant communications.

As indicated in FIG. 1, router 38 is coupled to wide area network (WAN) and/or local area network (LAN) connections to other hosts or other routers 38.

The host processors 34a-34d include central processing units (CPUs) 44 and memory 46.

I/O adapters 35a and 35b include an I/O adapter backplane 48 and multiple I/O adapter cards 50. Example adapter cards 50 illustrated in FIG. 1 include an SCSI adapter card; an adapter card to fiber channel hub and FC-AL devices; an Ethernet adapter card; and a graphics adapter card. Any known type of adapter card can be implemented. I/O adapters 35a and 35b also include a switch 36 in the I/O adapter backplane 48 to couple the adapter cards 50 to the SAN 32 fabric.

RAID subsystem 33 includes a microprocessor 52, memory 54, read/write circuitry 56, and multiple redundant storage disks 58.

SAN 32 handles data communications for I/O and IPC in distributed computer system 30. SAN 32 supports high-bandwidth and scalability required for I/O and also supports the extremely low latency and low CPU overhead required for IPC. User clients can bypass the operating system kernel process and directly access network communication hardware, such as SANICs 42 which enable efficient message passing protocols. SAN 32 is suited to current computing models and is a building block for new forms of I/O and computer cluster communication. SAN 32 allows I/O adapter nodes to communicate among themselves or communicate with any or all of the processor nodes in distributed computer system 30. With an I/O adapter attached to SAN 32, the resulting I/O adapter node has substantially the same communication capability as any processor node in distributed computer system 30.

Channel and Memory Semantics

In one embodiment, SAN 32 supports channel semantics and memory semantics. Channel semantics is sometimes referred to as send/receive or push communication operations, and is the type of communications employed in a traditional I/O channel where a source device pushes data and a destination device determines the final destination of the data. In channel semantics, the frame transmitted from a source process specifies a destination processes' communication port, but does not specify where in the destination processes' memory space the frame will be written. Thus, in channel semantics, the destination process pre-allocates where to place the transmitted data.

In memory semantics, a source process directly reads or writes the virtual address space of a remote node destination process. The remote destination process need only communicate the location of a buffer for data, and does not need to be involved with the transfer of any data. Thus, in memory semantics, a source process sends a data frame containing the destination buffer memory address of the destination process. In memory semantics, the destination process previously grants permission for the source process to access its memory.

Channel semantics and memory semantics are typically both necessary for I/O and IPC. A typical I/O operation employs a combination of channel and memory semantics. In an illustrative example I/O operation of distributed computer system 30, host processor 34a initiates an I/O operation by using channel semantics to send a disk write command to I/O adapter 35b. I/O adapter 35b examines the command and uses memory semantics to read the data buffer directly from the memory space of host processor 34a. After the data buffer is read, I/O adapter 35b employs channel semantics to push an I/O completion message back to host processor 34a.

In one embodiment, distributed computer system 30 performs operations that employ virtual addresses and virtual memory protection mechanisms to ensure correct and proper access to all memory. In one embodiment, applications running in distributed computed system 30 are not required to use physical addressing for any operations.

Queue Pairs

An example host processor node 34 is generally illustrated in FIG. 2. Host processor node 34 includes a process A indicated at 60 and a process B indicated at 62. Host processor node 34 includes SANIC 42. Host processor node 34 also includes queue pairs (QPs) 64a and 64b which provide communication between process 60 and SANIC 42. Host processor node 34 also includes QP 64c which provides communication between process 62 and SANIC 42. A single SANIC, such as SANIC 42 in a host processor 34, can support thousands of QPs. By contrast, a SAN interface in an I/O adapter 35 typically supports less than ten QPs.

Each QP 64 includes a send work queue 66 and a receive work queue 68. A process, such as processes 60 and 62, calls an operating-system specific programming interface which is herein referred to as verbs, which place work items, referred to as work queue elements (WQEs) onto a QP 64. A WQE is executed by hardware in SANIC 42. SANIC 42 is coupled to SAN 32 via physical link 40. Send work queue 66 contains WQEs that describe data to be transmitted on the SAN 32 fabric. Receive work queue 68 contains WQEs that describe where to place incoming data from the SAN 32 fabric.

Host processor node 34 also includes completion queue 70a interfacing with process 60 and completion queue 70b interfacing with process 62. The completion queues 70 contain information about completed WQEs. The completion queues are employed to create a single point of completion notification for multiple QPs. A completion queue entry is a data structure on a completion queue 70 that describes a completed WQE. The completion queue entry contains sufficient information to determine the QP that holds the completed WQE. A completion queue context is a block of information that contains pointers to, length, and other information needed to manage the individual completion queues.

Example WQEs include work items that initiate data communications employing channel semantics or memory semantics; work items that are instructions to hardware in SANIC 42 to set or alter remote memory access protections; and work items to delay the execution of subsequent WQEs posted in the same send work queue 66.

More specifically, example WQEs supported for send work queues 66 are as follows. A send buffer WQE is a channel semantic operation to push a local buffer to a remote QP's receive buffer. The send buffer WQE includes a gather list to combine several virtual contiguous local buffers into a single message that is pushed to a remote QP's receive buffer. The local buffer virtual addresses are in the address space of the process that created the local QP.

A remote direct memory access (RDMA) read WQE provides a memory semantic operation to read a virtually contiguous buffer on a remote node. The RDMA read WQE reads a virtually contiguous buffer on a remote endnode and writes the data to a virtually contiguous local memory buffer. Similar to the send buffer WQE, the local buffer for the RDMA read WQE is in the address space of the process that created the local QP. The remote buffer is in the virtual address space of the process owning the remote QP targeted by the RDMA read WQE.

A RDMA write WQE provides a memory semantic operation to write a virtually contiguous buffer on a remote node. The RDMA write WQE contains a scatter list of locally virtually contiguous buffers and the virtual address of the remote buffer into which the local buffers are written.

A RDMA FetchOp WQE provides a memory semantic operation to perform an atomic operation on a remote word. The RDMA FetchOp WQE is a combined RDMA read, modify, and RDMA write operation. The RDMA FetchOp WQE can support several read-modify-write operations, such as Compare and Swap if equal.

A bind/unbind remote access key (RKey) WQE provides a command to SANIC hardware to modify the association of a RKey with a local virtually contiguous buffer. The RKey is part of each RDMA access and is used to validate that the remote process has permitted access to the buffer.

A delay WQE provides a command to SANIC hardware to delay processing of the QP's WQEs for a specific time interval. The delay WQE permits a process to meter the flow of operations into the SAN fabric.

In one embodiment, receive work queues 68 only support one type of WQE, which is referred to as a receive buffer WQE. The receive buffer WQE provides a channel semantic operation describing a local buffer into which incoming send messages are written. The receive buffer WQE includes a scatter list describing several virtually contiguous local buffers. An incoming send message is written to these buffers. The buffer virtual addresses are in the address space of the process that created the local QP.

For IPC, a user-mode software process transfers data through QPs 64 directly from where the buffer resides in memory. In one embodiment, the transfer through the QPs bypasses the operating system and consumes few host instruction cycles. QPs 64 permit zero processor-copy data transfer with no operating system kernel involvement. The zero processor-copy data transfer provides for efficient support of high-bandwidth and low-latency communication.

Transport Services

When a QP 64 is created, the QP is set to provide a selected type of transport service. In one embodiment, a distributed computer system implementing the present invention supports four types of transport services.

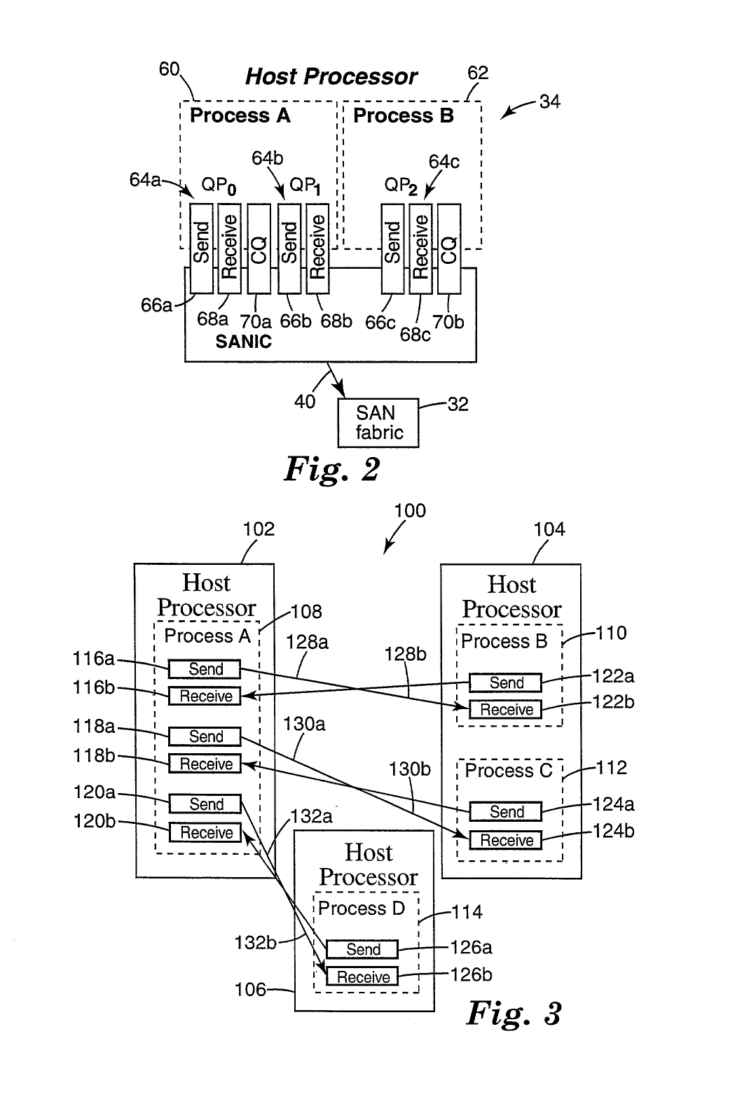

A portion of a distributed computer system employing a reliable connection service to communicate between distributed processes is illustrated generally at 100 in FIG. 3. Distributed computer system 100 includes a host processor node 102, a host processor node 104, and a host processor node 106. Host processor node 102 includes a process A indicated at 108. Host processor node 104 includes a process B indicated at 110 and a process C indicated at 112. Host processor node 106 includes a process D indicated at 114.

Host processor node 102 includes a QP 116 having a send work queue 116a and a receive work queue 116b; a QP 118 having a send work queue 118a and receive work queue 118b; and a QP 120 having a send work queue 120a and a receive work queue 120b which facilitate communication to and from process A indicated at 108. Host processor node 104 includes a QP 122 having a send work queue 122a and receive work queue 122b for facilitating communication to and from process B indicated at 110. Host processor node 104 includes a QP 124 having a send work queue 124a and receive work queue 124b for facilitating communication to and from process C indicated at 112. Host processor node 106 includes a QP 126 having a send work queue 126a and receive work queue 126b for facilitating communication to and from process D indicated at 114.

The reliable connection service of distributed computer system 100 associates a local QP with one and only one remote QP. Thus, QP 116 is connected to QP 122 via a non-sharable resource connection 128 having a non-sharable resource connection 128a from send work queue 116a to receive work queue 122b and a non-sharable resource connection 128b from send work queue 122a to receive work queue 116b. QP 118 is connected to QP 124 via a non-sharable resource connection 130 having a non-sharable resource connection 130a from send work queue 118a to receive work queue 124b and a non-sharable resource connection 130b from send work queue 124a to receive work queue 118b. QP 120 is connected to QP 126 via a non-sharable resource connection 132 having a non-sharable resource connection 132a from send work queue 120a to receive work queue 126b and a non-sharable resource connection 132b from send work queue 126a to receive work queue 120b.

A send buffer WQE placed on one QP in a reliable connection service causes data to be written into the receive buffer of the connected QP. RDMA operations operate on the address space of the connected QP.

The reliable connection service requires a process to create a QP for each process which is to communicate with over the SAN fabric. Thus, if each of N host processor nodes contain M processes, and all M processes on each node wish to communicate with all the processes on all the other nodes, each host processor node requires M²×(N−1) QPs. Moreover, a process can connect a QP to another QP on the same SANIC.

In one embodiment, the reliable connection service is made reliable because hardware maintains sequence numbers and acknowledges all frame transfers. A combination of hardware and SAN driver software retries any failed communications. The process client of the QP obtains reliable communications even in the presence of bit errors, receive buffer underruns, and network congestion. If alternative paths exist in the SAN fabric, reliable communications can be maintained even in the presence of failures of fabric switches or links.

In one embodiment, acknowledgements are employed to deliver data reliably across the SAN fabric. In one embodiment, the acknowledgement is not a process level acknowledgment, because the acknowledgment does not validate the receiving process has consumed the data. Rather, the acknowledgment only indicates that the data has reached its destination.

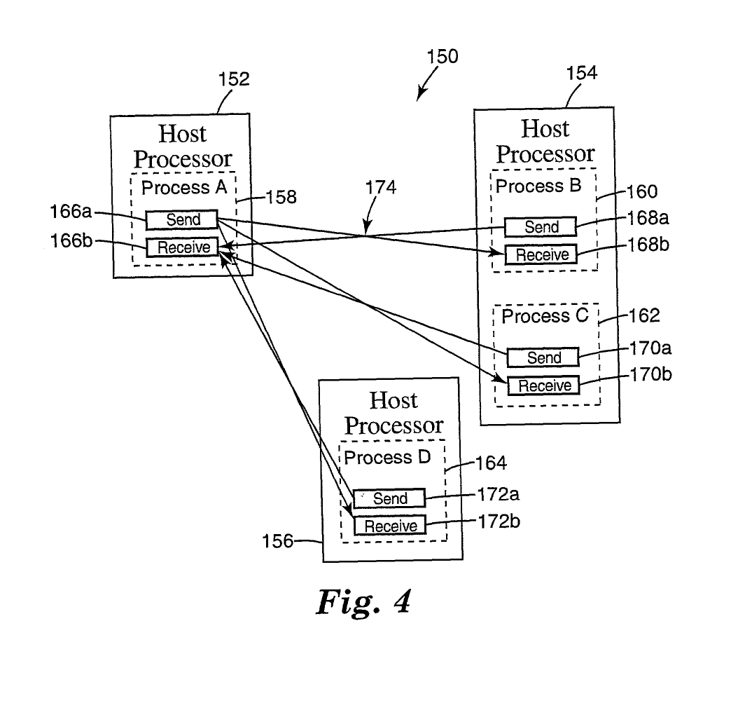

A portion of a distributed computer system employing a reliable datagram service to communicate between distributed processes is illustrated generally at 150 in FIG. 4. Distributed computer system 150 includes a host processor node 152, a host processor node 154, and a host processor node 156. Host processor node 152 includes a process A indicated at 158. Host processor node 154 includes a process B indicated at 160 and a process C indicated at 162. Host processor node 156 includes a process D indicated at 164.

Host processor node 152 includes QP 166 having send work queue 166a and receive work queue 166b for facilitating communication to and from process A indicated at 158. Host processor node 154 includes QP 168 having send work queue 168a and receive work queue 168b for facilitating communication from and to process B indicated at 160. Host processor node 154 includes QP 170 having send work queue 170a and receive work queue 170b for facilitating communication from and to process C indicated at 162. Host processor node 156 includes QP 172 having send work queue 172a and receive work queue 172b for facilitating communication from and to process D indicated at 164. In the reliable datagram service implemented in distributed computer system 150, the QPs are coupled in what is referred to as a connectionless transport service.

For example, a reliable datagram service 174 couples QP 166 to QPs 168, 170, and 172. Specifically, reliable datagram service 174 couples send work queue 166a to receive work queues 168b, 170b, and 172b. Reliable datagram service 174 also couples send work queues 168a, 170a, and 172a to receive work queue 166b.

The reliable datagram service permits a client process of one QP to communicate with any other QP on any other remote node. At a receive work queue, the reliable datagram service permits incoming messages from any send work queue on any other remote node.

In one embodiment, the reliable datagram service employs sequence numbers and acknowledgments associated with each message frame to ensure the same degree of reliability as the reliable connection service. End-to-end (EE) contexts maintain end-to-end specific state to keep track of sequence numbers, acknowledgments, and time-out values. The end-to-end state held in the EE contexts is shared by all the connectionless QPs communicating between a pair of endnodes. Each endnode requires at least one EE context for every endnode it wishes to communicate with in the reliable datagram service (e.g., a given endnode requires at least N EE contexts to be able to have reliable datagram service with N other endnodes).

The reliable datagram service greatly improves scalability because the reliable datagram service is connectionless. Therefore, an endnode with a fixed number of QPs can communicate with far more processes and endnodes with a reliable datagram service than with a reliable connection transport service. For example, if each of N host processor nodes contain M processes, and all M processes on each node wish to communicate with all the processes on all the other nodes, the reliable connection service requires M²×(N−1) QPs on each node. By comparison, the connectionless reliable datagram service only requires M QPs+(N−1) EE contexts on each node for exactly the same communications.

A third type of transport service for providing communications is a unreliable datagram service. Similar to the reliable datagram service, the unreliable datagram service is connectionless. The unreliable datagram service is employed by management applications to discover and integrate new switches, routers, and endnodes into a given distributed computer system. The unreliable datagram service does not provide the reliability guarantees of the reliable connection service and the reliable datagram service. The unreliable datagram service accordingly operates with less state information maintained at each endnode.

A fourth type of transport service is referred to as raw datagram service and is technically not a transport service. The raw datagram service permits a QP to send and to receive raw datagram frames. The raw datagram mode of operation of a QP is entirely controlled by software. The raw datagram mode of the QP is primarily intended to allow easy interfacing with traditional internet protocol, version 6 (IPv6) LAN-WAN networks, and further allows the SANIC to be used with full software protocol stacks to access transmission control protocol (TCP), user datagram protocol (UDP), and other standard communication protocols. Essentially, in the raw datagram service, SANIC hardware generates and consumes standard protocols layered on top of IPv6, such as TCP and UDP. The frame header can be mapped directly to and from an IPv6 header. Native IPv6 frames can be bridged into the SAN fabric and delivered directly to a QP to allow a client process to support any transport protocol running on top of IPv6. A client process can register with SANIC hardware in order to direct datagrams for a particular upper level protocol (e.g., TCP and UDP) to a particular QP. SANIC hardware can demultiplex incoming IPv6 streams of datagrams based on a next header field as well as the destination IP address.

SANIC and I/O Adapter Endnodes

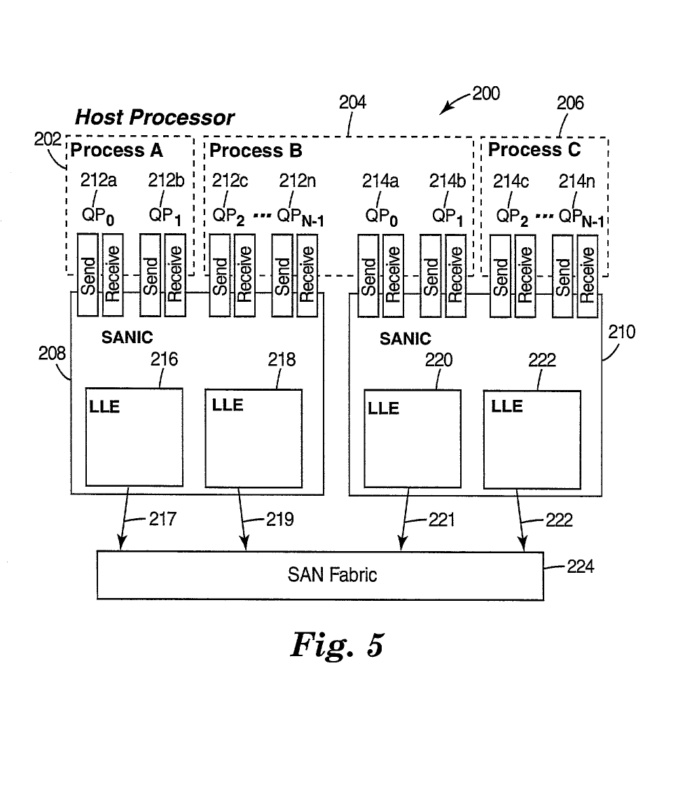

An example host processor node is generally illustrated at 200 in FIG. 5. Host processor node 200 includes a process A indicated at 202, a process B indicated at 204, and a process C indicated at 206. Host processor 200 includes a SANIC 208 and a SANIC 210. As discussed above, a host processor endnode or an I/O adapter endnode can have one or more SANICs. SANIC 208 includes a SAN link level engine (LLE) 216 for communicating with SAN fabric 224 via link 217 and an LLE 218 for communicating with SAN fabric 224 via link 219. SANIC 210 includes an LLE 220 for communicating with SAN fabric 224 via link 221 and an LLE 222 for communicating with SAN fabric 224 via link 223. SANIC 208 communicates with process A indicated at 202 via QPs 212a and 212b. SANIC 208 communicates with process B indicated at 204 via QPs 212c-212n. Thus, SANIC 208 includes N QPs for communicating with processes A and B. SANIC 210 includes QPs 214a and 214b for communicating with process B indicated at 204. SANIC 210 includes QPs 214c-214n for communicating with process C indicated at 206. Thus, SANIC 210 includes N QPs for communicating with processes B and C.

An LLE runs link level protocols to couple a given SANIC to the SAN fabric. RDMA traffic generated by a SANIC can simultaneously employ multiple LLEs within the SANIC which permits striping across LLEs. Striping refers to the dynamic sending of frames within a single message to an endnode's QP through multiple fabric paths. Striping across LLEs increases the bandwidth for a single QP as well as provides multiple fault tolerant paths. Striping also decreases the latency for message transfers. In one embodiment, multiple LLEs in a SANIC are not visible to the client process generating message requests. When a host processor includes multiple SANICs, the client process must explicitly move data on the two SANICs in order to gain parallelism. A single QP cannot be shared by SANICS. Instead a QP is owned by one local SANIC.

The following is an example naming scheme for naming and identifying endnodes in one embodiment of a distributed computer system according to the present invention. A host name provides a logical identification for a host node, such as a host processor node or I/O adapter node. The host name identifies the endpoint for messages such that messages are destine for processes residing on an endnode specified by the host name. Thus, there is one host name per node, but a node can have multiple SANICs.

A globally unique ID (GUID) identifies a transport endpoint. A transport endpoint is the device supporting the transport QPs. There is one GUID associated with each SANIC.

A local ID refers to a short address ID used to identify a SANIC within a single subnet. In one example embodiment, a subnet has up 2¹⁶ endnodes, switches, and routers, and the local ID (LID) is accordingly 16 bits. A source LID (SLID) and a destination LID (DLID) are the source and destination LIDs used in a local network header. A LLE has a single LID associated with the LLE, and the LID is only unique within a given subnet. One or more LIDs can be associated with each SANIC.

An internet protocol (IP) address (e.g., a 128 bit IPv6 ID) addresses a SANIC. The SANIC, however, can have one or more IP addresses associated with the SANIC. The IP address is used in the global network header when routing frames outside of a given subnet. LIDs and IP addresses are network endpoints and are the target of frames routed through the SAN fabric. All IP addresses (e.g., IPv6 addresses) within a subnet share a common set of high order address bits.

In one embodiment, the LLE is not named and is not architecturally visible to a client process. In this embodiment, management software refers to LLEs as an enumerated subset of the SANIC.

Switches and Routers

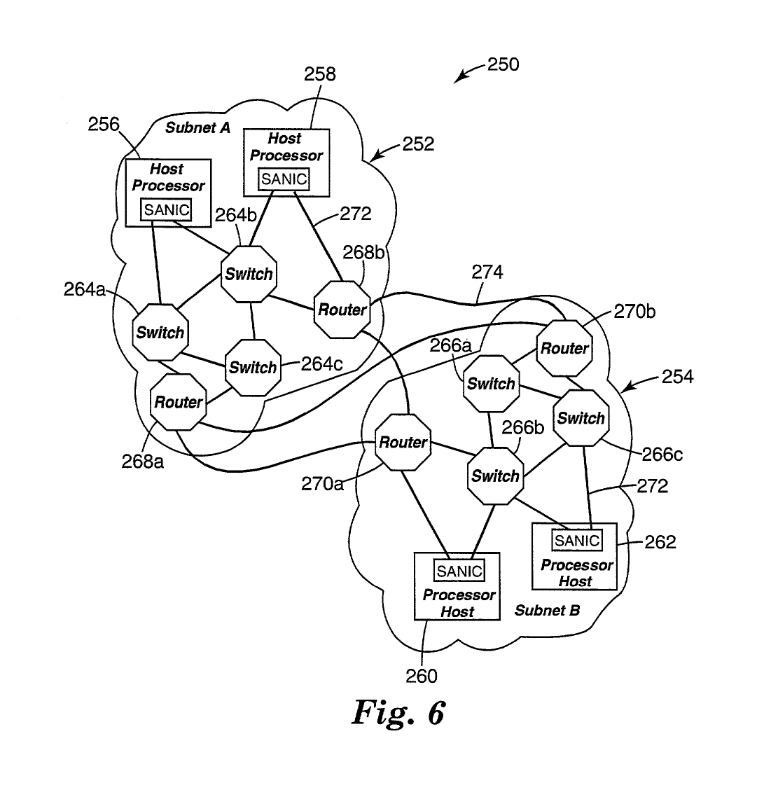

A portion of a distributed computer system is generally illustrated at 250 in FIG. 6. Distributed computer system 250 includes a subnet A indicated at 252 and a subnet B indicated at 254. Subnet A indicated at 252 includes a host processor node 256 and a host processor node 258. Subnet B indicated at 254 includes a host processor node 260 and host processor node 262. Subnet A indicated at 252 includes switches 264a-264c. Subnet B indicated at 254 includes switches 266a-266c. Each subnet within distributed computer system 250 is connected to other subnets with routers. For example, subnet A indicated at 252 includes routers 268a and 268b which are coupled to routers 270a and 270b of subnet B indicated at 254. In one example embodiment, a subnet has up to 2¹⁶ endnodes, switches, and routers.

A subnet is defined as a group of endnodes and cascaded switches that is managed as a single unit. Typically, a subnet occupies a single geographic or functional area. For example, a single computer system in one room could be defined as a subnet. In one embodiment, the switches in a subnet can perform very fast worm-hole or cut-through routing for messages.

A switch within a subnet examines the DLID that is unique within the subnet to permit the switch to quickly and efficiently route incoming message frames. In one embodiment, the switch is a relatively simple circuit, and is typically implemented as a single integrated circuit. A subnet can have hundreds to thousands of endnodes formed by cascaded switches.

As illustrated in FIG. 6, for expansion to much larger systems, subnets are connected with routers, such as routers 268 and 270. The router interprets the IP destination ID (e.g., IPv6 destination ID) and routes the IP like frame.

In one embodiment, switches and routers degrade when links are over utilized. In this embodiment, link level back pressure is used to temporarily slow the flow of data when multiple input frames compete for a common output. However, link or buffer contention does not cause loss of data. In one embodiment, switches, routers, and endnodes employ a link protocol to transfer data. In one embodiment, the link protocol supports an automatic error retry. In this example embodiment, link level acknowledgments detect errors and force retransmission of any data impacted by bit errors. Link-level error recovery greatly reduces the number of data errors that are handled by the end-to-end protocols. In one embodiment, the user client process is not involved with error recovery no matter if the error is detected and corrected by the link level protocol or the end-to-end protocol.

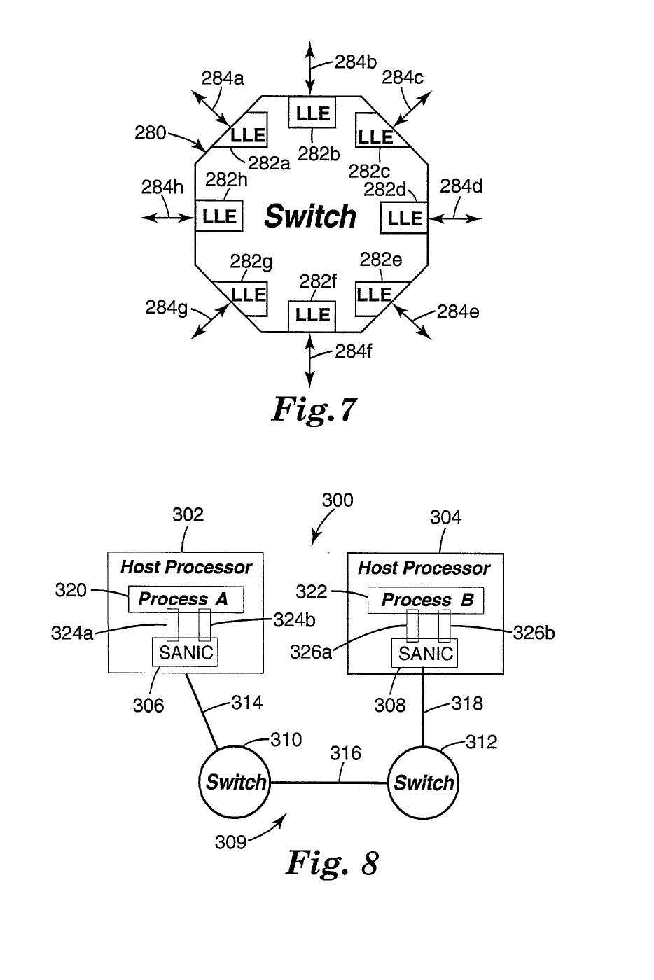

An example embodiment of a switch is generally illustrated at 280 in FIG. 7. Each I/O path on a switch or router has an LLE. For example, switch 280 includes LLEs 282a-282h for communicating respectively with links 284a-284h.

The naming scheme for switches and routers is similar to the above-described naming scheme for endnodes. The following is an example switch and router naming scheme for identifying switches and routers in the SAN fabric. A switch name identifies each switch or group of switches packaged and managed together. Thus, there is a single switch name for each switch or group of switches packaged and managed together.

Each switch or router element has a single unique GUID. Each switch has one or more LIDs and IP addresses (e.g., IPv6 addresses) that are used as an endnode for management frames.

Each LLE is not given an explicit external name in the switch or router. Since links are point-to-point, the other end of the link does not need to address the LLE.

Virtual Lanes

Switches and routers employ multiple virtual lanes within a single physical link. As illustrated in FIG. 6, physical links 272 connect endnodes, switches, and routers within a subnet. WAN or LAN connections 274 typically couple routers between subnets. Frames injected into the SAN fabric follow a particular virtual lane from the frame's source to the frame's destination. At any one time, only one virtual lane makes progress on a given physical link. Virtual lanes provide a technique for applying link level flow control to one virtual lane without affecting the other virtual lanes. When a frame on one virtual lane blocks due to contention, quality of service (QoS), or other considerations, a frame on a different virtual lane is allowed to make progress.

Virtual lanes are employed for numerous reasons, some of which are as follows. Virtual lanes provide QoS. In one example embodiment, certain virtual lanes are reserved for high priority or isonchronous traffic to provide QoS.

Virtual lanes provide deadlock avoidance. Virtual lanes allow topologies that contain loops to send frames across all physical links and still be assured the loops won't cause back pressure dependencies that might result in deadlock.

Virtual lanes alleviate head-of-line blocking. With virtual lanes, a blocked frames can pass a temporarily stalled frame that is destined for a different final destination.

In one embodiment, each switch includes its own crossbar switch. In this embodiment, a switch propagates data from only one frame at a time, per virtual lane through its crossbar switch. In another words, on any one virtual lane, a switch propagates a single frame from start to finish. Thus, in this embodiment, frames are not multiplexed together on a single virtual lane.

Paths in SAN fabric

Referring to FIG. 6, within a subnet, such as subnet A indicated at 252 or subnet B indicated at 254, a path from a source port to a destination port is determined by the LID of the destination SANIC port. Between subnets, a path is determined by the IP address (e.g., IPv6 address) of the destination SANIC port.

In one embodiment, the paths used by the request frame and the request frame's corresponding positive acknowledgment (ACK) or negative acknowledgment (NAK) frame are not required to be symmetric. In one embodiment employing oblivious routing, switches select an output port based on the DLID. In one embodiment, a switch uses one set of routing decision criteria for all its input ports. In one example embodiment, the routing decision criteria is contained in one routing table. In an alternative embodiment, a switch employs a separate set of criteria for each input port.

Each port on an endnode can have multiple IP addresses. Multiple IP addresses can be used for several reasons, some of which are provided by the following examples. In one embodiment, different IP addresses identify different partitions or services on an endnode. In one embodiment, different IP addresses are used to specify different QoS attributes. In one embodiment, different IP addresses identify different paths through intra-subnet routes.

In one embodiment, each port on an endnode can have multiple LIDs. Multiple LIDs can be used for several reasons some of which are provided by the following examples. In one embodiment, different LIDs identify different partitions or services on an endnode. In one embodiment, different LIDs are used to specify different QoS attributes. In one embodiment, different LIDs specify different paths through the subnet.

A one-to-one correspondence does not necessarily exist between LIDs and IP addresses, because a SANIC can have more or less LIDs than IP addresses for each port. For SANICs with redundant ports and redundant conductivity to multiple SAN fabrics, SANICs can, but are not required to, use the same LID and IP address on each of its ports.

Data Transactions

Referring to FIG. 1, a data transaction in distributed computer system 30 is typically composed of several hardware and software steps. A client process of a data transport service can be a user-mode or a kernel-mode process. The client process accesses SANIC 42 hardware through one or more QPs, such as QPs 64 illustrated in FIG. 2. The client process calls an operating-system specific programming interface which is herein referred to as verbs. The software code implementing the verbs intern posts a WQE to the given QP work queue.

There are many possible methods of posting a WQE and there are many possible WQE formats, which allow for various cost/performance design points, but which do not affect interoperability. A user process, however, must communicate to verbs in a well-defined manner, and the format and protocols of data transmitted across the SAN fabric must be sufficiently specified to allow devices to interoperate in a heterogeneous vendor environment.

In one embodiment, SANIC hardware detects WQE posting and accesses the WQE. In this embodiment, the SANIC hardware translates and validates the WQEs virtual addresses and accesses the data. In one embodiment, an outgoing message buffer is split into one or more frames. In one embodiment, the SANIC hardware adds a transport header and a network header to each frame. The transport header includes sequence numbers and other transport information. The network header includes the destination IP address or the DLID or other suitable destination address information. The appropriate local or global network header is added to a given frame depending on if the destination endnode resides on the local subnet or on a remote subnet.

A frame is a unit of information that is routed through the SAN fabric. The frame is an endnode-to-endnode construct, and is thus created and consumed by endnodes. Switches and routers neither generate nor consume request frames or acknowledgment frames. Instead switches and routers simply move request frames or acknowledgment frames closer to the ultimate destination. Routers, however, modify the frame's network header when the frame crosses a subnet boundary. In traversing a subnet, a single frame stays on a single virtual lane.

When a frame is placed onto a link, the frame is further broken down into flits. A flit is herein defined to be a unit of link-level flow control and is a unit of transfer employed only on a point-to-point link. The flow of flits is subject to the link-level protocol which can perform flow control or retransmission after an error. Thus, flit is a link-level construct that is created at each endnode, switch, or router output port and consumed at each input port. In one embodiment, a flit contains a header with virtual lane error checking information, size information, and reverse channel credit information.

If a reliable transport service is employed, after a request frame reaches its destination endnode, the destination endnode sends an acknowledgment frame back to the sender endnode. The acknowledgment frame permits the requestor to validate that the request frame reached the destination endnode. An acknowledgment frame is sent back to the requestor after each request frame. The requestor can have multiple outstanding requests before it receives any acknowledgments. In one embodiment, the number of multiple outstanding requests is determined when a QP is created.

Example Request and Acknowledgment Transactions

FIGS. 8, 9A, 9B, 10A, and 10B together illustrate example request and acknowledgment transactions. In FIG. 8, a portion of a distributed computer system is generally illustrated at 300. Distributed computer system 300 includes a host processor node 302 and a host processor node 304. Host processor node 302 includes a SANIC 306. Host processor node 304 includes a SANIC 308. Distributed computer system 300 includes a SAN fabric 309 which includes a switch 310 and a switch 312. SAN fabric 309 includes a link 314 coupling SANIC 306 to switch 310; a link 316 coupling switch 310 to switch 312; and a link 318 coupling SANIC 308 to switch 312.

In the example transactions, host processor node 302 includes a client process A indicated at 320. Host processor node 304 includes a client process B indicated at 322. Client process 320 interacts with SANIC hardware 306 through QP 324. Client process 322 interacts with SANIC hardware 308 through QP 326. QP 324 and 326 are software data structures. QP 324 includes send work queue 324a and receive work queue 324b. QP 326 includes send work queue 326a and receive work queue 326b.

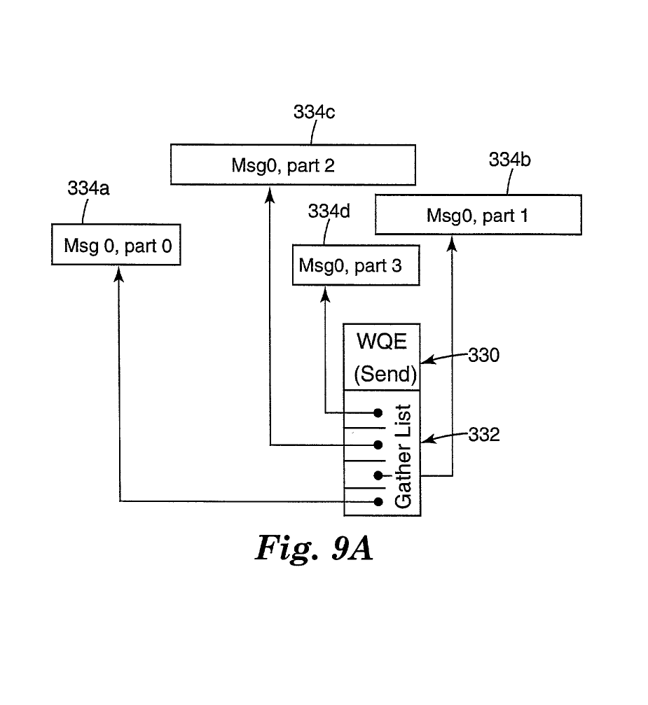

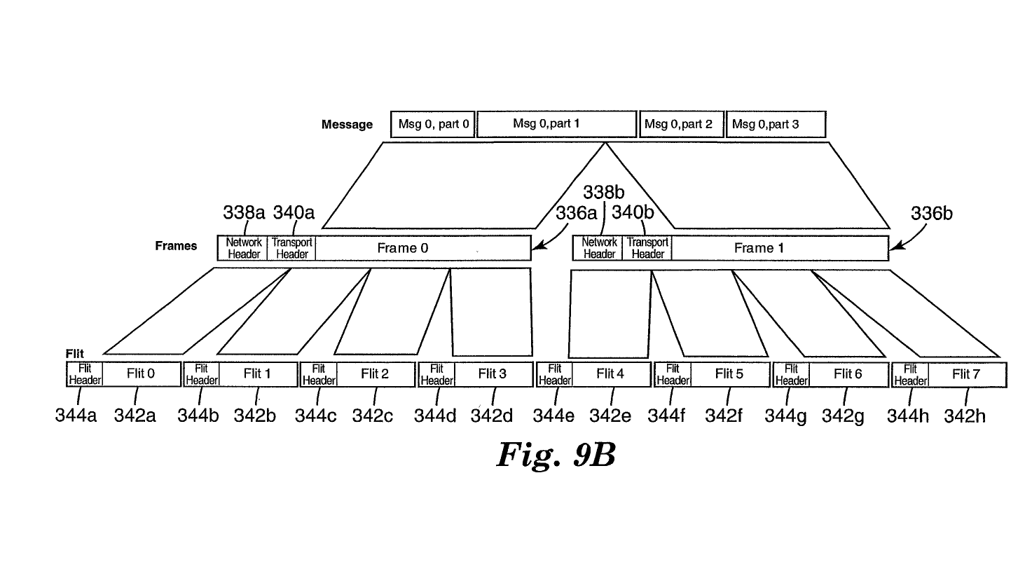

Process 320 initiates a message request by posting WQEs to send work queue 324a. Such a WQE is illustrated at 330 in FIG. 9A. The message request of client process 320 is referenced by a gather list 332 contained in send WQE 330. Each entry in gather list 332 points to a virtually contiguous buffer in the local memory space containing a part of the message, such as indicated by virtual contiguous buffers 334a-334d, which respectively hold message 0, parts 0, 1, 2, and 3.

Referring to FIG. 9B, hardware in SANIC 306 reads WQE 330 and packetizes the message stored in virtual contiguous buffers 334a-334d into frames and flits. As illustrated in FIG. 9B, all of message 0, part 0 and a portion of message 0, part 1 are packetized into frame 0, indicated at 336a. The rest of message 0, part 1 and all of message 0, part 2, and all of message 0, part 3 are packetized into frame 1, indicated at 336b. Frame 0 indicated at 336a includes network header 338a and transport header 340a. Frame 1 indicated at 336b includes network header 338b and transport header 340b.

As indicated in FIG. 9B, frame 0 indicated at 336a is partitioned into flits 0-3, indicated respectively at 342a-342d. Frame 1 indicated at 336b is partitioned into flits 4-7 indicated respectively at 342e-342h. Flits 342a through 342h respectively include flit headers 344a-344h.

Frames are routed through the SAN fabric, and for reliable transfer services, are acknowledged by the final destination endnode. If not successively acknowledged, the frame is retransmitted by the source endnode. Frames are generated by source endnodes and consumed by destination endnodes. The switches and routers in the SAN fabric neither generate nor consume frames.

Flits are the smallest unit of flow control in the network. Flits are generated and consumed at each end of a physical link. Flits are acknowledged at the receiving end of each link and are retransmitted in response to an error.

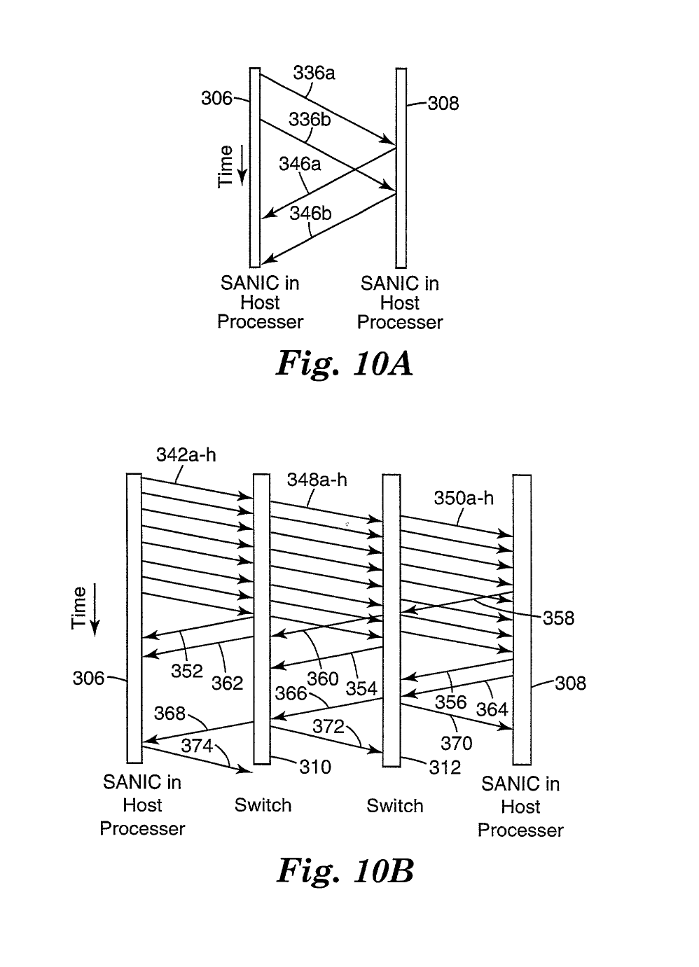

Referring to FIG. 10A, the send request message 0 is transmitted from SANIC 306 in host processor node 302 to SANIC 308 in host processor node 304 as frames 0 indicated at 336a and frame 1 indicated at 336b. ACK frames 346a and 346b, corresponding respectively to request frames 336a and 336b, are transmitted from SANIC 308 in host processor node 304 to SANIC 306 in host processor node 302.

In FIG. 10A, message 0 is being transmitted with a reliable transport service. Each request frame is individually acknowledged by the destination endnode (e.g., SANIC 308 in host processor node 304).

FIG. 10B illustrates the flits associated with the request frames 336 and acknowledgment frames 346 illustrated in FIG. 10A passing between the host processor endnodes 302 and 304 and the switches 310 and 312. As illustrated in FIG. 10B, an ACK frame fits inside one flit. In one embodiment, one acknowledgment flit acknowledges several flits.

As illustrated in FIG. 10B, flits 342a-h are transmitted from SANIC 306 to switch 310. Switch 310 consumes flits 342a-h at its input port, creates flits 348a-h at its output port corresponding to flits 342a-h, and transmits flits 348a-h to switch 312. Switch 312 consumes flits 348a-h at its input port, creates flits 350a-h at its output port corresponding to flits 348a-h, and transmits flits 350a-h to SANIC 308. SANIC 308 consumes flits 350a-h at its input port. An acknowledgment flit is transmitted from switch 310 to SANIC 306 to acknowledge the receipt of flits 342a-h. An acknowledgment flit 354 is transmitted from switch 312 to switch 310 to acknowledge the receipt of flits 348a-h. An acknowledgment flit 356 is transmitted from SANIC 308 to switch 312 to acknowledge the receipt of flits 350a-h.

Acknowledgment frame 346a fits inside of flit 358 which is transmitted from SANIC 308 to switch 312. Switch 312 consumes flits 358 at its input port, creates flit 360 corresponding to flit 358 at its output port, and transmits flit 360 to switch 310. Switch 310 consumes flit 360 at its input port, creates flit 362 corresponding to flit 360 at its output port, and transmits flit 362 to SANIC 306. SANIC 306 consumes flit 362 at its input port. Similarly, SANIC 308 transmits acknowledgment frame 346b in flit 364 to switch 312. Switch 312 creates flit 366 corresponding to flit 364, and transmits flit 366 to switch 310. Switch 310 creates flit 368 corresponding to flit 366, and transmits flit 368 to SANIC 306.

Switch 312 acknowledges the receipt of flits 358 and 364 with acknowledgment flit 370, which is transmitted from switch 312 to SANIC 308. Switch 310 acknowledges the receipt of flits 360 and 366 with acknowledgment flit 372, which is transmitted to switch 312. SANIC 306 acknowledges the receipt of flits 362 and 368 with acknowledgment flit 374 which is transmitted to switch 310.

Architecture Layers and Implementation Overview

A host processor endnode and an I/O adapter endnode typically have quite different capabilities. For example, an example host processor endnode might support four ports, hundreds to thousands of QPs, and allow incoming RDMA operations, while an attached I/O adapter endnode might only support one or two ports, tens of QPs, and not allow incoming RDMA operations. A low-end attached I/O adapter alternatively can employ software to handle much of the network and transport layer functionality which is performed in hardware (e.g., by SANIC hardware) at the host processor endnode.

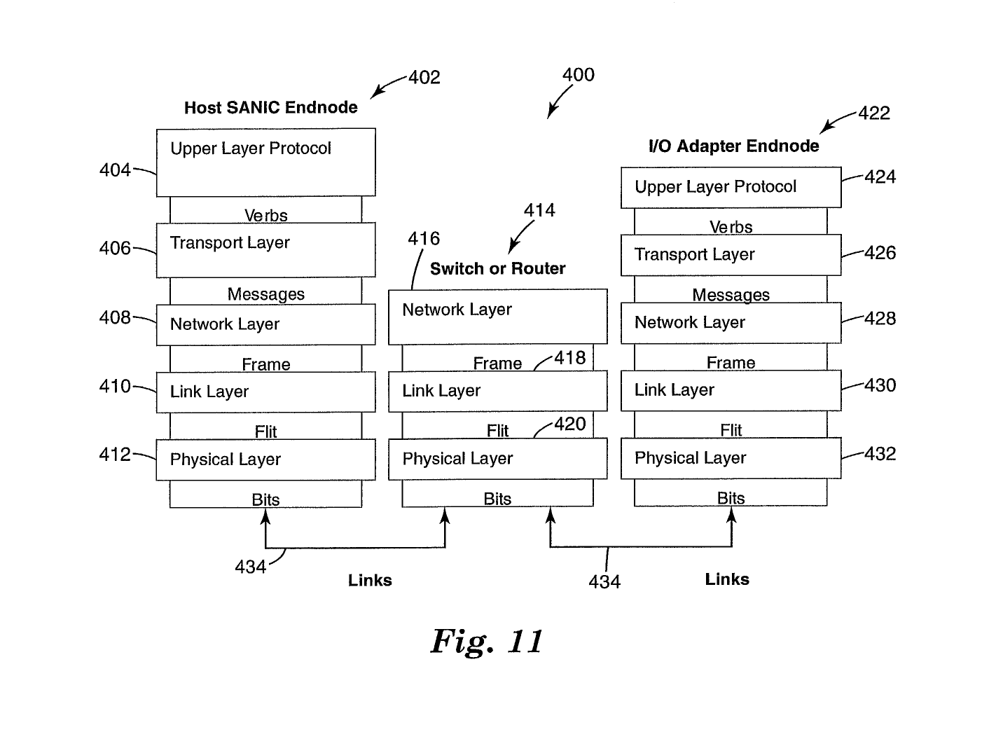

One embodiment of a layered architecture for implementing the present invention is generally illustrated at 400 in diagram form in FIG. 11. The layered architecture diagram of FIG. 11 shows the various layers of data communication paths, and organization of data and control information passed between layers.

Host SANIC endnode layers are generally indicated at 402. The host SANIC endnode layers 402 include an upper layer protocol 404; a transport layer 406; a network layer 408; a link layer 410; and a physical layer 412.

Switch or router layers are generally indicated at 414. Switch or router layers 414 include a network layer 416; a link layer 418; and a physical layer 420.

I/O adapter endnode layers are generally indicated at 422. I/O adapter endnode layers 422 include an upper layer protocol 424; a transport layer 426; a network layer 428; a link layer 430; and a physical layer 432.

The layered architecture 400 generally follows an outline of a classical communication stack. The upper layer protocols employ verbs to create messages at the transport layers. The transport layers pass messages to the network layers. The network layers pass frames down to the link layers. The link layers pass flits through physical layers. The physical layers send bits or groups of bits to other physical layers. Similarly, the link layers pass flits to other link layers, and don't have visibility to how the physical layer bit transmission is actually accomplished. The network layers only handle frame routing, without visibility to segmentation and reassembly of frames into flits or transmission between link layers.

Bits or groups of bits are passed between physical layers via links 434. Links 434 can be implemented with printed circuit copper traces, copper cable, optical cable, or with other suitable links.

The upper layer protocol layers are applications or processes which employ the other layers for communicating between endnodes.

The transport layers provide end-to-end message movement. In one embodiment, the transport layers provide four types of transport services as described above which are reliable connection service; reliable datagram service; unreliable datagram service; and raw datagram service.

The network layers perform frame routing through a subnet or multiple subnets to destination endnodes.

The link layers perform flow-controlled, error controlled, and prioritized frame delivery across links.

The physical layers perform technology-dependent bit transmission and reassembly into flits.

Access Control

An endnode is preferably protected against unauthorized access at various levels, such as application process level, kernal level, hardware level, and the like. One way to prevent unauthorized access is to restrict routes through the SAN fabric. Additional levels of protection can be provided via other services, such as partitioning or other access control mechanisms employed by middleware, which are not discussed below.

Source Route Restrictions

In one embodiment, source route restrictions are implemented in a switch where the source endnode attaches to the SAN fabric. In one embodiment, management messages required to configure source route restrictions are provided to configure a given switch. In one embodiment, a default source route restriction is unlimited access within a subnet or between subnets. In one embodiment, routers include source route restrictions. In other embodiments, a SANIC of an endnode or an adapter of an I/O adapter endnode provide a similar type access control mechanism to protect the node from unauthorized access.

In one example embodiment of a source route restriction mechanism implemented in a switch, a small number of access control bits are employed which are associated with each switch input port. In this example embodiment, the switch resource requirements are limited to the number of ports times the number of access control bits.

The following example Table I provides example two-bit access control values and the corresponding frame route access allowed through the corresponding switch port.

TABLE I

| Access | |
|---|---|
| Control | |
| Value | Frame Route Access Allowed |
| 0 | No Access-the sender may not route any frames through |
| | this port. |
| 1 | The sender is allowed to issue management enumeration frames |
| | and to perform base discovery operations. |
| 2 | The sender is allowed to issue management control messages |
| | (e.g., update the switch/router tables, reset the switch, etc.). |
| 3 | The sender may route application data and connection |
| | management frames. |

In one embodiment, a more robust resource route restriction implementation provides a set of access control bits per DLID. However, providing a set of access control bits per DLID requires additional resources and complexity, such as additional management messages, and possibly for global headers, the storage and mapping of source IPv6 addresses. This source router restriction access control implementation permits a switch to provide more fine-grain access control on a per source/destination tuple or application partition basis.

Hardware Firewall

In one embodiment, a switch, a router, a SANIC of an endnode, or an adapter of an I/O adapter endnode includes a hardware firewall which limits which endnodes may route to other endnodes or across subnets. In one example embodiment, a hardware firewall in a router is configured to restrict access to a given subnet or individual endnode. In one example embodiment, the hardware firewall in the router is configured to define a subnet mask or to define individual source addresses which are protocol dependent which may access the subnet or route to or from a given node within a subnet.

In one embodiment, a hardware firewall is constructed in a switch by expanding the switch's route table to include an additional source/destination access rights table.

Access Control Based on Frame Header Field

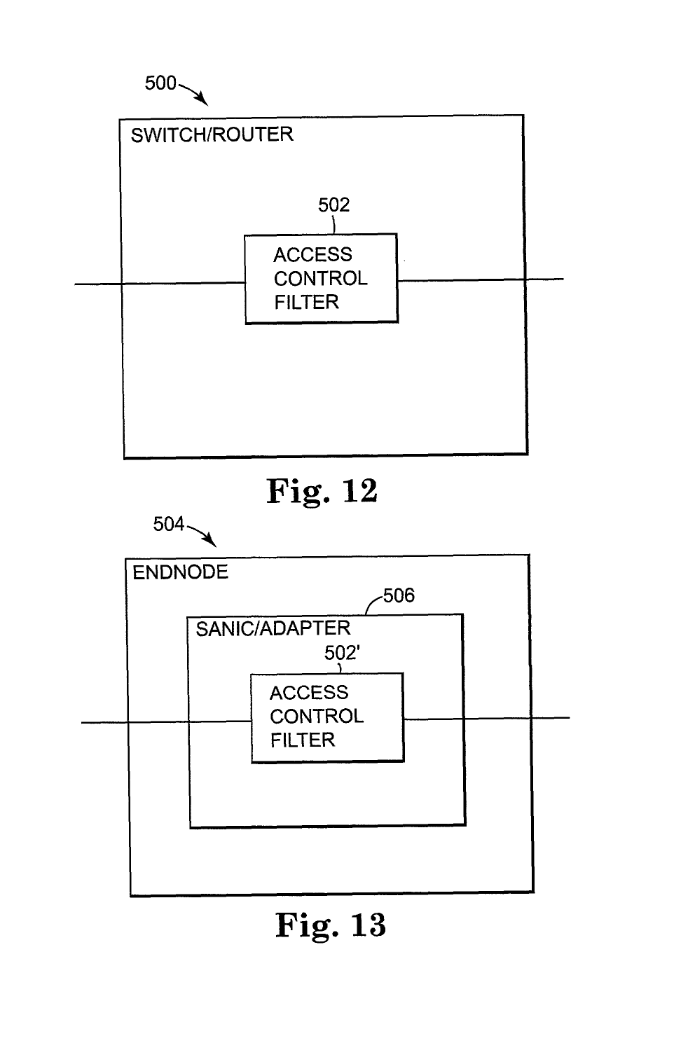

One embodiment of a switch or router is generally indicated at 500 in FIG. 12. Switch/router 500 includes an access control filter 502 which restricts routes of frames from at least one end station on a selected routing path based on the contents of a selected frame header field. In one embodiment, the restriction provided by access control filter 502 restricts all N end stations or a subset (from 1 to N−1 in size) of the N end stations on a selected routing path from injecting/receiving frames based on a selected frame header field. In one embodiment, access control filter 502 is implemented in hardware.

One embodiment of an endnode is generally illustrated at 504 in FIG. 13. Endnode 504 includes a SANIC or adapter 506, (i.e., element 506 is a SANIC if endnode 504 is a processor endnode or an I/O adapter endnode and element 506 is an adapter if endnode 504 is an I/O adapter endnode). SANIC/adapter 506 includes an access control filter 502′ which is similar to access control filter 502 of switch/router 500. Access control filter 502′ restricts routes of frames from at least one end station on a selected routing path based on the contents of a selected frame header field. In one embodiment, the restriction provided by access control filter 502′ restricts all N end stations or a subset (from 1 to N−1 in size) of the N end stations on a selected routing path from injecting/receiving frames based on a selected frame header field. In one embodiment, access control filter 502′ is implemented in hardware.

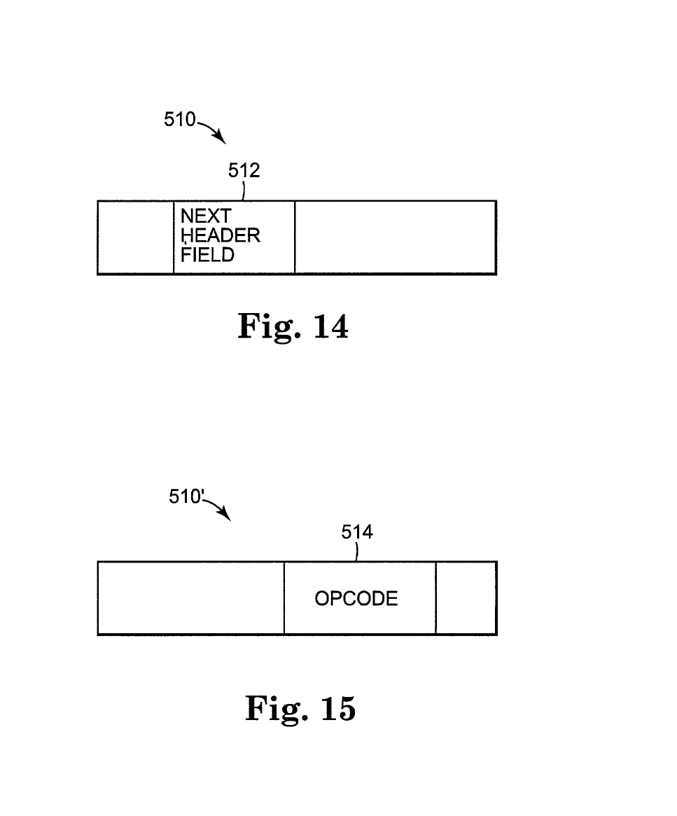

One embodiment of a frame header is generally illustrated in diagram form at 510 in FIG. 14. Frame header 510 includes a next header field 512. In one embodiment, access control filter 502/502′ filters based on a next header field, such as next header field 512 of frame header 510, to thereby restrict routes of frames from at least one end station on a selected routing path based on the next header field. The next header field contains the frame header type or frame type that is being routed from the switch, router, SANIC, or adapter. In one example embodiment where access control filter 502/502′ filters based on the next header field of the frame header, if the next header field indicates that the frame is a raw datagram frame, the route could be restricted so that the raw datagram frame would not enter selected routes. For example, a raw datagram frame could be the result of someone attempting to maliciously spoof the computer system. Thus, in this example embodiment, if the next header field indicates that the frame is a raw datagram frame, the frame could be determined to be forwarded or not be forwarded from inbound port to outbound port on a per port basis based on whether the route path should be sending raw datagram frames.

One embodiment of a frame header is generally illustrated in diagram form at 510′ in FIG. 15. Frame header 510′ includes an opcode field 514. Opcode field 514 contains an opcode which indicates the type of operation being attempted with the given frame transmission. Example types of operations which can be indicated in opcode field 514 include management operations, data operations, and route update operations.

In one embodiment, access control filter 502/502′ restricts routes of frames from at least one end station on a selected routing path based on an opcode field, such as opcode field 514 of frame header 510′. In this embodiment, routes of frames from at least one switch, router, SANIC, and/or adapter can be restricted based on the exact type of operation that is being attempted, such as a management operation, a data operation, or a route update operation. Since the exact type of operation can be restricted by the access control filter 502/502′ in this embodiment, restricting route access based on an opcode field provides much more fine-grain capabilities compared to other known filtering techniques. For example, a conventional access control filtering based on ports can identify service, such as a web server identification or the like, and accordingly filter based on services, but cannot filter based on the exact type of operation being attempted.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A network system comprising:
links;
end stations coupled between the links, wherein types of end stations include endnodes which originate or consume frames and routing devices which route frames between the links, wherein at least one end station includes:
an access control filter configured to restrict routes of frames from at least one end station on a selected routing path based on a selected frame header field.

2. The network system of claim 1 wherein the at least one end station having the access control filter includes at least one routing device.

3. The network system of claim 2 wherein the at least routing device having the access control filter includes at least one switch.

4. The network system of claim 2 wherein the at least routing device having the access control filter includes at least one router.

5. The network system of claim 1 wherein the at least one end station having the access control filter includes at least one endnode.

6. The network system of claim 1 wherein the at least one endnode having the access control filter includes at least one processor endnode.

7. The network system of claim 6 wherein the at least one processor endnode includes a network interface controller which includes the access control filter.

8. The network system of claim 1 wherein the at least one endnode having the access control filter includes at least one input/output (I/O) adapter endnode.

9. The network system of claim 8 wherein the at least I/O adapter endnode includes an I/O adapter which includes the access control filter.

10. The network system of claim 1 wherein the access control filter in the at least one end station is implemented in hardware.

11. The network system of claim 1 wherein the selected frame header field comprises a next header field.

12. The network system of claim 11 wherein the access control filter restricts selected frame types indicated in the next header field from entering selected routes.

13. The network system of claim 11 wherein the access control filter restricts raw datagram frames indicated in the next header field from entering selected routes.

14. The network system of claim 1 wherein the selected frame header field comprises an opcode field.

15. The network system of claim 14 wherein the access control filter restricts routes of frames based on a type of operation being attempted as indicated in the opcode field.

16. The network system of claim 15 wherein the type of operation being attempted is a management operation.

17. The network system of claim 15 wherein the type of operation being attempted is a data operation.

18. The network system of claim 15 wherein the type of operation being attempted is a route update operation.

19. An end station configured to operated in a network system having end stations coupled between links, the end station comprising:
an access control filter configured to restrict routes of frames from at least one end station on a selected routing path based on a selected frame header field.

20. The end station of claim 19 wherein the end station is a routing device which routes frames between the links.

21. The end station of claim 20 wherein the routing device comprises a switch.

22. The end station of claim 20 wherein the routing device comprises a router.

23. The end station of claim 19 wherein the end station is an endnode which originates or consumes frames.

24. The end station of claim 23 wherein the endnode is a processor endnode.

25. The end station of claim 24 wherein the processor endnode includes a network interface controller which includes the access control filter.

26. The end station of claim 23 wherein the endnode is an input/output (I/O) adapter endnode.

27. The end station of claim 26 wherein the I/O adapter endnode includes an I/O adapter which includes the access control filter.

28. The end station of claim 19 comprising hardware which implements the access control filter.

29. The end station of claim 19 wherein the selected frame header field comprises a next header field.

30. The end station of claim 29 wherein the access control filter restricts selected frame types indicated in the next header field from entering selected routes.

31. The end station of claim 29 wherein the access control filter restricts raw datagram frames indicated in the next header field from entering selected routes.

32. The end station of claim 19 wherein the selected frame header field comprises an opcode field.

33. The end station of claim 32 wherein the access control filter restricts routes of frames based on a type of operation being attempted as indicated in the opcode field.

34. The end station of claim 33 wherein the type of operation being attempted is a management operation.

35. The end station of claim 33 wherein the type of operation being attempted is a data operation.

36. The end station of claim 33 wherein the type of operation being attempted is a route update operation.

37. A routing device configured to route frames between the links in a network system, the routing device comprising:
an access control filter configured to restrict routes of frames from at least one end station on a selected routing path based on a selected frame header field.

38. The routing device of 37 wherein the routing device comprises a switch having the access control filter.

39. The routing device of claim 37 wherein the routing device comprises a router having the access control filter.

40. The routing device of claim 37 wherein the selected frame header field comprises a next header field.

41. The routing device of claim 37 wherein the selected frame header field comprises an opcode field.

42. An endnode configured to originates or consumes frames in a network system, the endnode comprising:
an access control filter configured to restrict routes of frames from at least one end station on a selected routing path based on a selected frame header field.

43. The endnode of claim 42 wherein the endnode is a processor endnode.

44. The endnode of claim 43 wherein the processor endnode includes a network interface controller which includes the access control filter.

45. The endnode of claim 42 wherein the endnode is an input/output (I/O) adapter endnode.

46. The endnode of claim 45 wherein the I/O adapter endnode includes an I/O adapter which includes the access control filter.

47. The endnode of claim 42 wherein the selected frame header field comprises a next header field.

48. The endnode of claim 42 wherein the selected frame header field comprises an opcode field.

49. A method of controlling access in a network system having links and end stations coupled between the links, wherein types of end stations include endnodes which originate or consume frames and routing devices which route frames between the links, wherein the method comprises:
restricting routes of frames from at least one end station on a selected routing path based on a selected frame header field.

50. The method of claim 49 wherein the restricting includes restricting routes of frames from or through at least one routing device.

51. The method of claim 49 wherein the restricting includes restricting routes of frames from or through at least one switch.

52. The method of claim 49 wherein the restricting includes restricting routes of frames from or through at least one router.

53. The method of claim 49 wherein the restricting includes restricting routes of frames from or through at least one endnode.

54. The method of claim 49 wherein the restricting includes restricting routes of frames from or through at least one processor endnode.

55. The method of claim 54 wherein the restricting is performed by a network interface controller.

56. The method of claim 49 wherein the restricting includes restricting routes of frames from or through at least one input/output (I/O) adapter endnode.

57. The method of claim 56 wherein the restricting is performed by an I/O adapter.

58. The method of claim 49 wherein the restricting is performed by hardware.

59. The method of claim wherein the selected frame header field comprises a next header field.

60. The method of claim 59 wherein the restricting includes restricting selected frame types indicated in the next header field from entering selected routes.

61. The method of claim 59 wherein the restricting includes restricting raw datagram frames indicated in the next header field from entering selected routes.

62. The method of claim 1 wherein the selected frame header field comprises an opcode field.

63. The method of claim 62 wherein the restricting includes restricting routes of frames based on a type of operation being attempted as indicated in the opcode field.

64. The method of claim 63 wherein the type of operation being attempted is a management operation.

65. The method of claim 63 wherein the type of operation being attempted is a data operation.

66. The method of claim 63 wherein the type of operation being attempted is a route update operation.
